(19) United States
(12) Patent Application Publication
(10) Pub. No.: US 2025/0377484 A1
(43) Pub. Date: Dec. 11, 2025

(54) STACKED METALENS SURFACES FOR 3D SENSORS

(71) Applicant: Applied Materials, Inc., Santa Clara, CA (US)

(72) Inventors: Jinxin FU, Fremont, CA (US); Yangyang SUN, San Jose, CA (US); Ludovic GODET, Sunnyvale, CA (US)

(21) Appl. No.: 19/306,743

(22) Filed: Aug. 21, 2025

Related U.S. Application Data
(62) Division of application No. 17/655,857, filed on Mar. 22, 2022.
(60) Provisional application No. 63/164,899, filed on Mar. 23, 2021.

(51) Int. Cl. G02B 1/00; G02B 27/30; G02B 27/42

(52) U.S. Cl. CPC G02B 1/002; G02B 27/30; G02B 27/4233

(57) ABSTRACT

Embodiments of the present disclosure relate to a sensor apparatuses with stacked metasurfaces suitable for small form factors. The apparatus is a sensing apparatus operable to be used in sensing applications. The apparatus includes a light source and an optical device. The optical device includes multiple metasurfaces. The optical device includes a collimation metasurface disposed on a substrate to collimate one or more laser beams from the light source. The one or more laser beams propagate through the substrate to a diffractive metasurface. The diffractive metasurface diffracts the collimated one or more laser beams into diffraction beams.

### CROSS-REFERENCE TO RELATED APPLICATIONS

This Application is a Division of application Ser. No. 17/655,857 filed on Mar. 22, 2022. Application Ser. No. 17/655,857 claims the benefit of U.S. Provisional Application 63/164,899 filed on Mar. 23, 2021, which is herein incorporated by reference in its entirety.

### BACKGROUND

### Field

Embodiments of the present disclosure generally relate to optical devices. More specifically, embodiments described herein relate to a sensor apparatuses with stacked metasurfaces suitable for small form factors.

### Description of the Related Art

Many sensor apparatuses utilize bulk lenses to collimate and diffract light for sensing applications, e.g., facial identification sensors. The sensor apparatuses including the bulk lenses generally have a large form factor, making them costly and time consuming to manufacture. It is desirable to, when manufacturing sensor apparatuses to utilize a high yield and low cost method. The flat optical devices include arrangements of structures with sub-micron dimensions, e.g., nanosized dimensions. Optical devices including flat optical devices may consist of a single layer or multiple layers of sub-micron structures. Accordingly, what is needed in the art is a sensor apparatus with stacked metasurfaces suitable for small form factors.

### SUMMARY

In one embodiment, an apparatus is provided. The apparatus includes a light source operable to project one or more laser beams. The apparatus further includes an optical device. The optical device includes a substrate. The substrate includes a first surface and a second surface. The second surface is opposite the first surface and the first surface is exposed to the light source. The apparatus further includes a collimation metasurface disposed on the first surface. The collimation metasurface includes a first plurality of optical device structures operable to collimate the one or more laser beams through the substrate. The apparatus further includes a diffractive metasurface disposed on the second surface. The diffractive metasurface includes a second plurality of optical device structures to diffract the one or more laser beams into diffraction beams.

In another embodiment, an apparatus is provided. The apparatus includes a light source operable to project one or more laser beams. The apparatus further includes an optical device. The optical device includes a substrate. The substrate includes a first surface and a second surface. The second surface is opposite the first surface. The apparatus further includes a field metasurface substrate coupled to the first surface. The field metasurface substrate includes a third surface exposed to the light source. The apparatus further includes a field metasurface disposed on the third surface. The field metasurface includes a first plurality of optical device structures. The apparatus further includes a collimation metasurface disposed on the first surface. The collimation metasurface includes a second plurality of optical device structures operable to collimate the one or more laser beams through the substrate. The apparatus further includes a diffractive metasurface disposed on the second surface. The diffractive metasurface includes a third plurality of optical device structures to diffract the one or more laser beams into diffraction beams.

In yet another embodiment, an apparatus is provided. The apparatus includes a light source operable to project one or more laser beams. The apparatus further includes an optical device. The optical device includes a substrate. The substrate includes a first surface and a second surface. The second surface is opposite the first surface and the first surface is exposed to the light source. The apparatus further includes a collimation metasurface disposed on the first surface. The collimation metasurface includes a first plurality of optical device structures operable to collimate the one or more laser beams through the substrate. The first plurality of optical device structures are arranged in a phase profile. The phase profile includes a structure width of the first plurality of optical device structures that varies from a center point of the phase profile to an exterior edge of the phase profile. The phase profile further includes a diffractive metasurface disposed on the second surface. The diffractive metasurface includes a second plurality of optical device structures to diffract the one or more laser beams into diffraction beams.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIGS. 1A-1D are schematic, cross-sectional views of an apparatus according to embodiments.

FIGS. 2A and 2B are schematic, cross-sectional views of an optical device according to embodiments.

FIGS. 3A and 3B are schematic, perspective views of a plurality of optical device structures according to embodiments.

FIG. 4 is a schematic, top view of a phase profile according to embodiments.

FIGS. 5A and 5B are schematic, top views of an array of a plurality of optical device structures according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. More specifically, embodiments described herein relate to a sensor apparatuses with stacked metasurfaces suitable for small form factors. The sensor apparatuses are operable to be utilized as three-dimensional sensors for sensing applications.

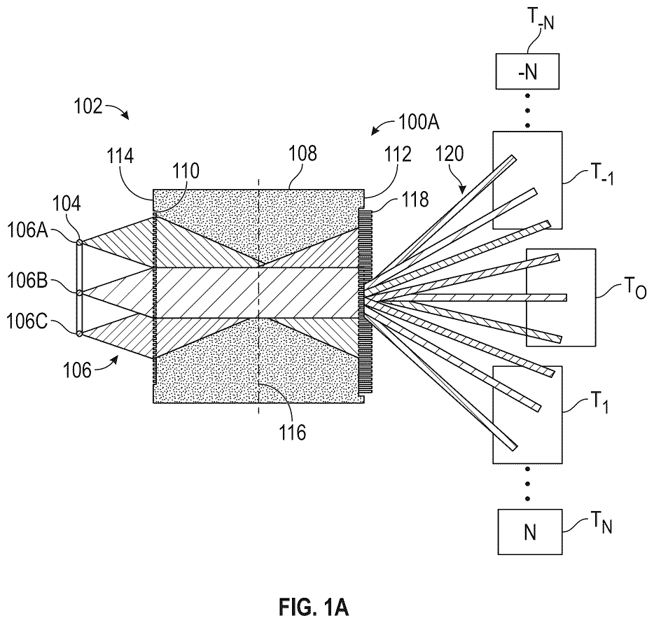

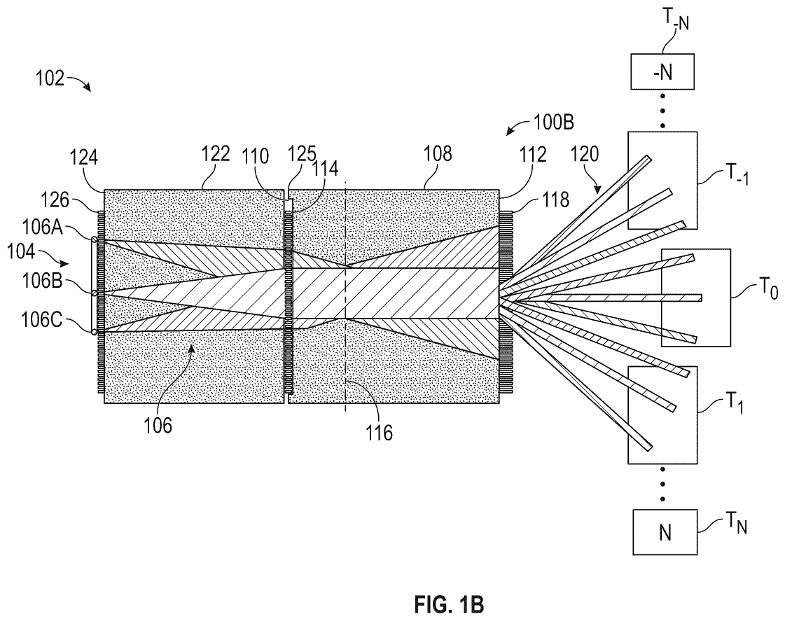

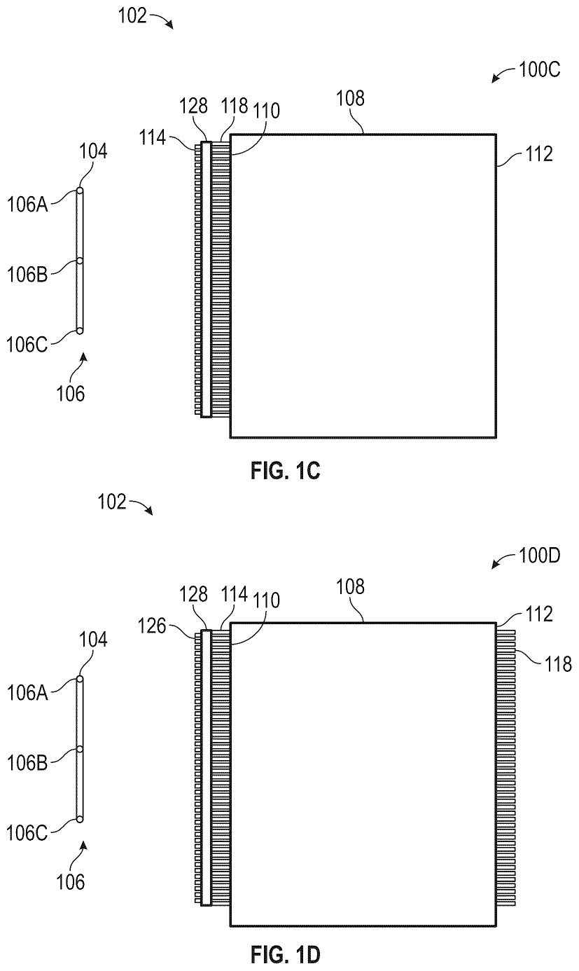

FIG. 1A is a schematic, cross-sectional view of an apparatus 100A. The apparatus 100A includes an optical device 102 and a light source 104. In one embodiment, which can be combined with other embodiments described herein, the apparatus 100A is a dot matrix projector. In another embodiment, which can be combined with other embodiments described herein, the apparatus 100A is a dot matrix diffuser.

The light source 104 is disposed opposite of the optical device 102. The light source 104 is operable to project one or more laser beams 106 to the optical device 102. In one embodiment, which can be combined with other embodiments described herein, the one or more laser beams 106 are infrared lasers. In another embodiment, which can be combined with other embodiments described herein, the light source 104 is an array of vertical cavity surface-emitting laser (VCSEL) devices.

The one or more laser beams 106 (i.e., a first laser beam 106A, a second laser beam 106B, and a third laser beam 106C) are incident on the optical device 102. The one or more laser beams 106 each have a wavelength between about 400 nm and about 2 μm. In one embodiment, which can be combined with other embodiments described herein, the one or more laser beams 106 have the same wavelength. In another embodiment, which can be combined with other embodiments described herein, the one or more laser beams 106 each have a different wavelength. Although three laser beams 106 (i.e., the first laser beam 106A, the second laser beam 106B, and the third laser beam 106C) are shown in FIG. 1A, the apparatus 100A may include one or more laser beams 106 projected from the light source 104.

The optical device 102 includes a device substrate 108, a collimation metasurface 114, and a diffractive metasurface 118. The device substrate 108 can be any substrate used in the art, and can be either opaque or transparent depending on the use of the device substrate 108. The device substrate 108 includes a first surface 110 and a second surface 112. The first surface 110 is opposite the second surface 112. The first surface 110 is exposed to the light source 104. Substrate selection may include substrates of any suitable material, including, but not limited to, amorphous dielectrics, non-amorphous dielectrics, crystalline dielectrics, silicon oxide, polymers, or combinations thereof. Suitable examples may include an oxide, sulfide, phosphide, telluride, or combinations thereof. For example, the device substrate 108 includes silicon (Si), silicon dioxide (SiO₂), germanium (Ge), silicon germanium (SiGe), InP, GaAs, GaN, fused silica, quartz, sapphire, and high-index transparent materials such as high-refractive-index glass, combinations thereof, or any other suitable materials. Additionally, substrate selection may further include varying shapes, thickness, and diameters of the device substrate 108. For example, the device substrate 108 may have a circular, rectangular, or square shape.

The collimation metasurface 114 is disposed on the first surface 110 of the device substrate 108. The collimation metasurface 114 converts the one or more laser beams 106 to parallel propagating beams. The one or more laser beams are incident on the collimation metasurface and propagate through the device substrate 108. The diffractive metasurface 118 is disposed on the second surface 112 of the device substrate 108. The diffractive metasurface 118 is a beam splitter. The diffractive metasurface 118 splits the one or more laser beams 106 into diffraction beams 120. The one or more laser beams 106 are collimated and propagate towards an axis 116 in the device substrate 108. For example, the first laser beam 106A, the second laser beam 106B, and the third laser beam 106C intersect at the axis 116 and propagate towards the diffractive metasurface 118 to be diffracted into the diffraction beams 120.

The diffraction beams 120 have one or more diffraction orders n with a highest order N and a negative highest order −N. As shown in FIG. 1A, a highest order N (T_{N}) beam diffracted is a first-order mode (T₁) beam and a negative highest order −N (T_{-N}) beam diffracted is a negative first-order mode (T₋₁) beam. A zero-order mode (T₀) beam is also diffracted. The highest order N and the negative highest order −N are not limited to the first-order mode (T₁) beam or negative first-order mode (T₋₁) beam. The diffraction beams 120 do not have an upper limit on the highest order N and the negative highest order −N.

FIG. 1B is a schematic, cross-section view of an apparatus 100B. The apparatus 100B includes an optical device 102 and a light source 104. In one embodiment, which can be combined with other embodiments described herein, the apparatus 100B is a dot matrix projector. In another embodiment, which can be combined with other embodiments described herein, the apparatus 100B is a dot matrix diffuser.

The light source 104 is disposed opposite of the optical device 102. The light source 104 is operable to project one or more laser beams 106 to the optical device 102. In one embodiment, which can be combined with other embodiments described herein, the one or more laser beams 106 are infrared lasers. In another embodiment, which can be combined with other embodiments described herein, the light source 104 is an array of vertical cavity surface-emitting laser (VCSEL) devices.

The one or more laser beams 106 (i.e., a first laser beam 106A, a second laser beam 106B, and a third laser beam 106C) are incident on the optical device 102. The one or more laser beams 106 each have a wavelength between about 400 nm and about 2 μm. In one embodiment, which can be combined with other embodiments described herein, the one or more laser beams 106 have the same wavelength. In another embodiment, which can be combined with other embodiments described herein, the one or more laser beams 106 each have a different wavelength. Although three laser beams 106 (i.e., the first laser beam 106A, the second laser beam 106B, and the third laser beam 106C) are shown in FIG. 1B, the apparatus 100B may include one or more laser beams 106 projected from the light source 104.

The optical device 102 includes a device substrate 108, a field metasurface substrate 122, a collimation metasurface 114, a diffractive metasurface 118, and a field metasurface 126. The device substrate 108 includes a first surface 110 and a second surface 112. The first surface 110 is opposite the second surface 112. The field metasurface substrate 122 and the device substrate 108 can be any substrate used in the art, and can be either opaque or transparent depending on the use of the field metasurface substrate 122 and the device substrate 108. The field metasurface substrate 122 is coupled to the first surface of the device substrate 108. The field metasurface substrate 122 includes a third surface 124 and a fourth surface 125. The third surface 124 is opposite of the fourth surface 125. The third surface 124 is exposed to the light source 104. Substrate selection may include substrates of any suitable material, including, but not limited to, amorphous dielectrics, non-amorphous dielectrics, crystalline dielectrics, silicon oxide, polymers, or combinations thereof. Suitable examples may include an oxide, sulfide, phosphide, telluride, or combinations thereof. For example, the device substrate 108 and the field metasurface substrate 122 include silicon (Si), silicon dioxide (SiO₂), germanium (Ge), silicon germanium (SiGe), InP, GaAs, GaN, fused silica, quartz, sapphire, and high-index transparent materials such as high-refractive-index glass, combinations thereof, or other suitable materials. Additionally, substrate selection may further include varying shapes, thickness, and diameters of the device substrate 108 and the field metasurface substrate 122. For example, the device substrate 108 and the field metasurface substrate 122 can have a circular, rectangular, or square shape.

The field metasurface 126 is disposed on the third surface 124 of the field metasurface substrate 122. The field metasurface 126 improves the efficiency of the one or more laser beams 106 propagating through the optical device 102. The field metasurface 126 converges the one or more laser beams 106 propagating through the optical device 102. Additionally, the field metasurface 126 improves the efficiency of the one or more laser beams 106 propagating through the optical device 102. The one or more laser beams 106 are incident on the field metasurface 126 and propagate towards the device substrate 108.

The collimation metasurface 114 is disposed on the first surface 110 of the device substrate 108. The collimation metasurface 114 converts the one or more laser beams 106 to parallel propagating beams. The one or more laser beams are incident on the collimation metasurface and propagate through the device substrate 108. The diffractive metasurface 118 is disposed on the second surface 112 of the device substrate 108. The diffractive metasurface 118 is a beam splitter. The diffractive metasurface 118 splits the one or more laser beams 106 into diffraction beams 120. The one or more laser beams 106 are collimated and propagate towards an axis 116 in the device substrate 108. For example, the first laser beam 106A, the second laser beam 106B, and the third laser beam 106C intersect at the axis 116 and propagate towards the diffractive metasurface 118 to be diffracted into the diffraction beams 120.

The diffraction beams 120 have one or more diffraction orders n with a highest order N and a negative highest order −N. As shown in FIG. 1A, a highest order N (T_{N}) beam diffracted is a first-order mode (T₁) beam and a negative highest order −N (T_{-N}) beam diffracted is a negative first-order mode (T₋₁) beam. A zero-order mode (T₀) beam is also diffracted. The highest order N and the negative highest order −N are not limited to the first-order mode (T₁) beam or negative first-order mode (T₋₁) beam. The diffraction beams 120 do not have an upper limit on the highest order N and the negative highest order −N.

FIG. 1C is a schematic, cross-section view of an apparatus 100C. In one embodiment, which can be combined with other embodiments described herein, the diffractive metasurface 118 is disposed on the first surface 110. Therefore, the one or more laser beams 106 are incident on the collimation metasurface 114 and propagate to the diffractive metasurface 118 to form the diffraction beams 120. As shown in FIG. 1C, a spacer layer 128 may be disposed between the collimation metasurface 114 and the diffractive metasurface 118. The spacer layer 128 provides for the one or more laser beams 106 to avoid near field coupling between the collimation metasurface 114 and the diffractive metasurface 118. The spacer layer 128 has a thickness between about 1 μm to about 2 mm.

FIG. 1D is a schematic, cross-section view of an apparatus 100D. In one embodiment, which can be combined with other embodiments described herein, the field metasurface 126 is disposed on the first surface 110. Therefore, the one or more laser beams 106 are incident on the field metasurface 126 and propagate to the collimation metasurface 114 to collimate the one or more laser beams 106. As shown in FIG. 1D, a spacer layer 128 is disposed between the collimation metasurface 114 and the field metasurface 126. The spacer layer 128 provides for the one or more laser beams 106 to avoid near field coupling between the collimation metasurface 114 and the field metasurface 126. The spacer layer 128 has a thickness between about 1 μm to about 2 mm.

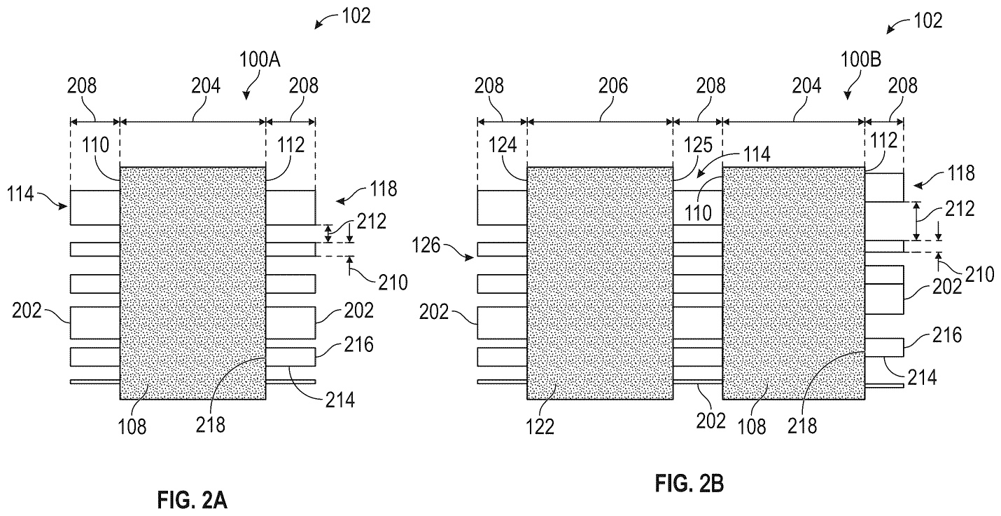

FIG. 2A is schematic, cross-sectional view of an optical device 102 of the apparatus 100A. The optical device 102 includes a device substrate 108. The device substrate 108 includes a first surface 110 and a second surface 112. A substrate thickness 204 of the device substrate 108 is between about 50 μm and about 2 mm. The optical device 102 includes a collimation metasurface 114 and a diffractive metasurface 118.

The collimation metasurface and the diffractive metasurface 118 include a plurality of optical device structures 202. The plurality of optical device structures 202 are disposed on the first surface 110 and the second surface 112 of the device substrate 108. The plurality of optical device structures 202 include a sidewall 214, a bottom surface 218, and a top surface 216. The plurality of optical devices include, but are not limited to, materials containing one or more of silicon (Si), silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (SisN₄), zirconium dioxide (ZrO₂), niobium oxide (Nb₂O₅), cadmium stannate (Cd₂SnO₄), silicon carbon-nitride (SiCN), hafnium dioxide (HfO₂), combinations thereof, or other suitable materials. The refractive index of the plurality of optical device structures 202 is between about 1.3 and about 4.5.

A structure thickness 208 of the each of the plurality of optical device structures 202 is between about 100 nm and about 5 μm. In one embodiment, which can be combined with other embodiments described herein, the structure thickness 208 is the same or substantially the same for each of the plurality of optical device structures 202. In another embodiment, which can be combined with other embodiments described herein, structure thickness 208 varies for the plurality of optical device structures.

The plurality of optical device structures 202 each have a structure width 210. The structure width 210 is between about 20 nm to about 600 nm. In one embodiment, which can be combined with other embodiments described herein, the structure width 210 is the same or substantially the same for each of the plurality of optical device structures 202. In another embodiment, which can be combined with other embodiments described herein, the structure width 210 varies for the plurality of optical device structures 202. In yet another embodiment, which can be combined with other embodiments described herein, the structure width 210 of each of the plurality of optical device structures 202 gradually increases from the bottom surface 218 to the top surface 216. The structure width 210 determines a phase delay of the optical device 102.

A pitch 212 is defined as the distance between adjacent optical device structures 202. The pitch 212 is between about 200 nm and about 50 μm. The average pitch 212 is between 200 nm to 1 μm. In one embodiment, which can be combined with other embodiments described herein, the pitch 212 is the same or substantially the same for each adjacent optical device structure of the plurality of optical device structures 202. In another embodiment, which can be combined with other embodiments described herein, the pitch 212 varies for the plurality of optical device structures across the device substrate 108 and the field metasurface substrate 122.

FIG. 2B is schematic, cross-sectional view of an optical device 102 of the apparatus 100B. The optical device 102 includes a device substrate 108. The device substrate 108 includes a first surface 110 and a second surface 112. A substrate thickness 204 of the device substrate 108 is between about 50 μm and about 2 mm. The optical device 102 includes a field metasurface substrate 122. The field metasurface substrate 122 includes a third surface 124 and a fourth surface 125. A field metasurface substrate thickness 206 is between about 50 μm and about 2 mm. In one embodiment, which can be combined with other embodiments described herein, the field metasurface substrate thickness 206 is equal to or substantially equal to the substrate thickness 204. In another embodiment, which can be combined with other embodiments described herein, the field metasurface substrate thickness 206 is different from the substrate thickness 204. The optical device 102 includes a field metasurface 126, a collimation metasurface 114, and a diffractive metasurface 118.

The field metasurface 126, the collimation metasurface 114, and the diffractive metasurface 118 include a plurality of optical device structures 202. The plurality of optical device structures 202 are disposed on the first surface 110 and the second surface 112 of the device substrate 108 and the third surface 124 of the field metasurface substrate 122. The plurality of optical device structures 202 include a sidewall 214, a bottom surface 218, and a top surface 216.

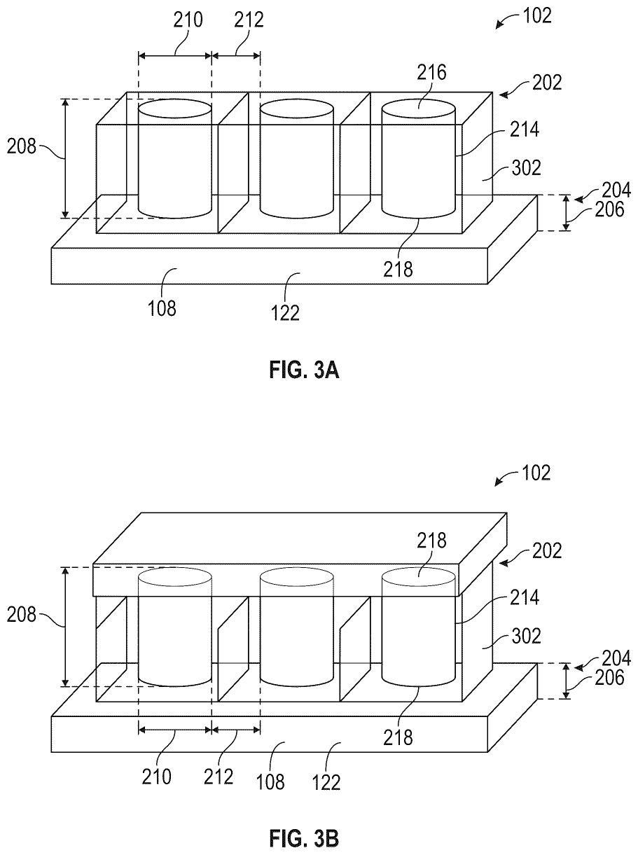

FIGS. 3A and 3B are schematic, perspective views of a plurality of optical device structures 202. The plurality of optical device structures 202 are disposed on a device substrate 108 or a field metasurface substrate 122. Although FIGS. 3A and 3B depict the plurality of optical device structures 202 as having circular shaped cross-sections, the cross-sections of the optical device structures 202 may have other shapes including, but not limited to, square, rectangular, triangular, elliptical, regular polygonal, irregular polygonal, and/or irregular shaped cross-sections. In one embodiment, which can be combined with other embodiments described herein, the plurality of optical device structures 202 have the same cross sections across the device substrate 108 or the field metasurface substrate 122. In another embodiment, which can be combined with other embodiments described herein, the plurality of optical device structures 202 have varying cross sections across the device substrate 108 or the field metasurface substrate 122.

The plurality of optical device structures 202 are encapsulated with an encapsulation material 302. The encapsulation material 302 contacts a sidewall 214 of the plurality of optical device structures 202. In one embodiment, which can be combined with other embodiments described herein, the encapsulation material 302 is deposited to be conformal over the plurality of optical device structures 202. The encapsulation material 302 is a low refractive index material. For example, the encapsulation material 302 has a refractive index of between about 1.1 and about 2.0. The encapsulation material 302 includes, but is not limited to, one or more of a polymer, a resin, a silicon-containing material such as silicon dioxide (SiO₂), silicon oxynitride (SiON), and silicon carbon nitride (SiCN), other suitable materials, or combinations thereof. As shown in FIG. 3B, the encapsulation material 302 is disposed over a top surface 216 of the plurality of optical device structures 202.

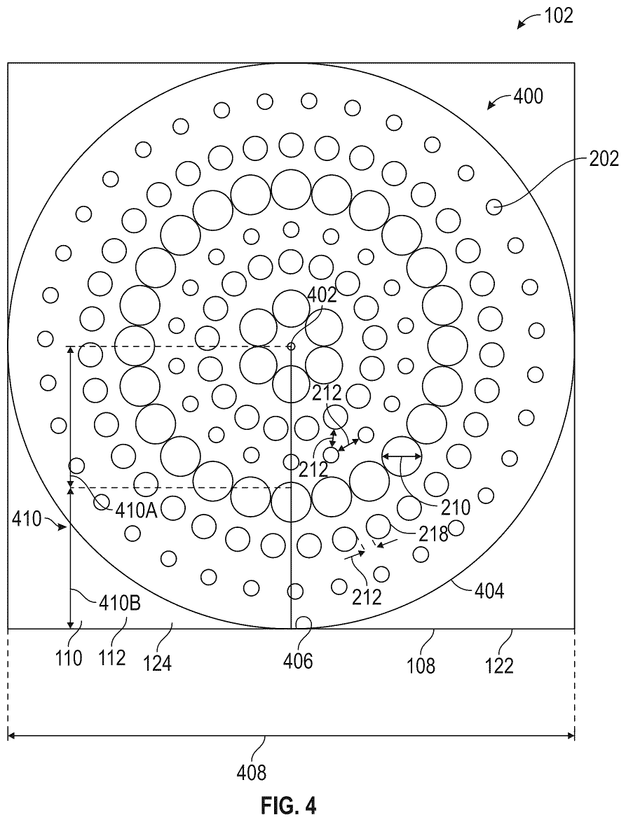

FIG. 4 is a schematic, top view of a phase profile 400. The phase profile 400 is operable to be utilized in an optical device 102. In one embodiment, which can be combined with other embodiments described herein, the phase profile 400 of a plurality of optical device structures 202 is utilized in a collimation metasurface 114 on a first surface 110 of a device substrate 108. In another embodiment, which can be combined with other embodiments described herein, the phase profile 400 of the plurality of optical device structures 202 is utilized in a diffractive metasurface 118 on a second surface 112 of the device substrate 108. In yet another embodiment, which can be combined with other embodiments described herein, the phase profile 400 of the plurality of optical device structures 202 is utilized in a field metasurface 126 on a third surface 124 of a field metasurface substrate 122. The field metasurface 126 improves the light collection efficiency of the optical device 102. The collimation metasurface 114, the diffractive metasurface 118, and the field metasurface 126 may have a metasurface width 408 of between about 50 μm to about 10 nm.

The plurality of optical device structures 202 in the phase profile 400 are arranged such that the pitch 212 between adjacent optical device structures of the plurality of optical device structures 202 varies from a center point 402 of the phase profile 400 along a radial axis 406 to an exterior edge 404 of the phase profile 400. The variation may be an increase of the pitch 212 followed by a decrease of the pitch 212. The increase and decrease of the pitch 212 may be repeated to the exterior edge 404.

The structure width 210 of the plurality of optical device structures 202 in the phase profile 400 varies from a center point 402 of the phase profile 400 along a radial axis 406 to an exterior edge of the phase profile 400. For example, the structure width 210 repeatedly decreases and increases from a center point 402 of the phase profile 400 along a radial axis 406 to an exterior edge of the phase profile 400 in a plurality of cycles 410. The plurality of cycles 410 each include the plurality of optical device structures 202 having the structure width 210 varying from decreasing to increasing along the radial axis 406. For example, as shown in FIG. 4, a first cycle 410A includes the structure width 210 of the plurality of optical device structures 202 decreasing and a second cycle 410B includes the structure width 210 of the plurality of optical device structures 202 decreasing. The structure width 210 of the plurality of optical device structures 202 increases between the first cycle 410A and the second cycle 410B. Although only 2 of the plurality of cycles 410 are shown in FIG. 4, more than 2 of the plurality of cycles 410 may be included in the phase profile 400.

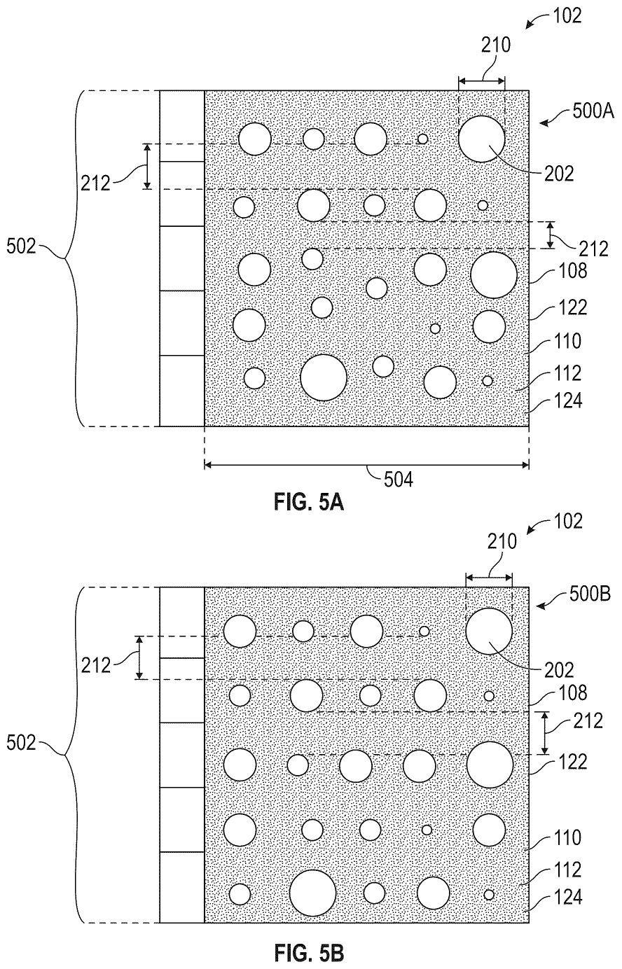

FIG. 5A is a schematic, top view of an array 500A of a plurality of optical device structures 202. In one embodiment, which can be combined with other embodiments described herein, multiple arrays 500A may be conjoined to form a collimation metasurface 114 on a first surface 110 of a device substrate 108. In another embodiment, which can be combined with other embodiments described herein, multiple arrays 500A may be conjoined to form a diffractive metasurface 118 on a second surface 112 of the device substrate 108. In yet another embodiment, which can be combined with other embodiments described herein, multiple arrays 500A may be conjoined to form a field metasurface 126 on a third surface 124 of a field metasurface substrate 122.

An array width 504 of the array 500A is between about 1 μm to about 20 μm. Multiple arrays 500A may be combined to form the collimation metasurface 114, the diffractive metasurface 118, or the field metasurface 126 in an X-Y grid, a square lattice, a random array, a hexagonal lattice, or any other suitable configuration.

In one embodiment, which can be combined with other embodiments described herein, the structure width 210 is the same or substantially the same for each of the plurality of optical device structures 202 in the array 500A. In another embodiment, which can be combined with other embodiments described herein, the structure width 210 varies for the plurality of optical device structures in the array 500A.

The array 500A includes a plurality of rows 502. The array 500A is a non-periodic array. For example, a pitch 212 between adjacent optical device structures of the plurality of optical device structures 202 in adjacent rows of the plurality of rows 502 varies.

FIG. 5B is a schematic, top view of an array 500B of a plurality of optical device structures 202. In one embodiment, which can be combined with other embodiments described herein, multiple arrays 500B may be conjoined to form a collimation metasurface 114 on a first surface 110 of a device substrate 108. In another embodiment, which can be combined with other embodiments described herein multiple arrays 500B may be conjoined to form a diffractive metasurface 118 on a second surface 112 of the device substrate 108. In yet another embodiment, which can be combined with other embodiments described herein, multiple arrays 500B may be conjoined to form a field metasurface 126 on a third surface 124 of a field metasurface substrate 122.

An array width 504 of the array 500B is between about 1 μm to about 20 μm. Multiple arrays 500A may be combined to form the collimation metasurface 114, the diffractive metasurface 118, or the field metasurface 126 in an X-Y grid, a square lattice, a random array, a hexagonal lattice, or any other suitable configuration.

In one embodiment, which can be combined with other embodiments described herein, the structure width 210 is the same or substantially the same for each of the plurality of optical device structures 202 in the array 500A. In another embodiment, which can be combined with other embodiments described herein, the structure width 210 varies for the plurality of optical device structures in the array 500A.

The array 500B includes a plurality of rows 502. The array 500A is a periodic array. For example, a pitch 212 between adjacent optical device structures 202 of the plurality of optical device structures 202 in adjacent rows 502 of the plurality of rows 502 is constant. The pitch 212 is between about 200 nm and about 1 μm.

In summation, embodiments described herein provide for a sensor apparatuses with stacked metasurfaces suitable for small form factors. The apparatus includes a light source and an optical device. The optical device includes multiple metasurfaces. The optical device includes a collimation metasurface disposed on a substrate to collimate one or more laser beams from the light source. The one or more laser beams propagate through the substrate to a diffractive metasurface. The diffractive metasurface diffracts the collimated one or more laser beams into diffraction beams. In some embodiments, a field metasurface is included in the apparatus to improve the efficiency and amount of light from the light source to the optical device. The apparatus including the multiple metasurfaces will have a smaller form factor compared to sensor apparatuses utilizing bulk lenses. Therefore, the cost of manufacturing the sensor apparatuses and the yield of the sensor apparatuses will improve.

While the foregoing is directed to examples of the present disclosure, other and further examples of the disclosure may be devised without departing from the basic scope thereof, and the scope thereof is determined by the claims that follow.

What is claimed is:

1. An apparatus, comprising:
a light source operable to project one or more laser beams; and
an optical device, the optical device comprising:
a substrate, the substrate having a first surface and a second surface, the second surface opposite the first surface;
a field metasurface disposed on the first surface, the field metasurface including a first plurality of optical device structures;
a collimation metasurface disposed on the first surface, the collimation metasurface including a second plurality of optical device structures operable to collimate the one or more laser beams through the substrate;
a spacer layer disposed between the collimation metasurface and the field metasurface to avoid near field coupling between the collimation metasurface and the field metasurface; and
a diffractive metasurface disposed on the second surface, the diffractive metasurface including a third plurality of optical device structures to diffract the one or more laser beams into diffraction beams.

2. The apparatus of claim 1, wherein the substrate includes a substrate thickness of between about 50 μm and about 2 mm.

3. The apparatus of claim 1, wherein the first plurality of optical device structures and the second plurality of optical device structures include a structure width of between about 20 nm to about 600 nm.

4. The apparatus of claim 1, wherein the collimation metasurface, the diffractive metasurface, and the field metasurface have a structure thickness between about 100 nm and about 5 μm.

5. The apparatus of claim 1, wherein the spacer layer has a thickness between about 1 μm to about 2 mm.

6. The apparatus of claim 1, wherein the first plurality of optical device structures and the second plurality of optical device structures include materials containing silicon (Si), silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon carbon-nitride (SiCN), hafnium dioxide (HfO₂), or combinations thereof.

7. The apparatus of claim 1, wherein the light source is an array of vertical cavity surface-emitting laser (VCSEL) devices.

8. The apparatus of claim 1, wherein the diffractive metasurface is multiple arrays of the second plurality of optical device structures, the multiple arrays operable to be an X-Y grid, a square lattice, a random array, or a hexagonal lattice.

9. The apparatus of claim 8, wherein the multiple arrays have an array width between about 1 μm to 20 μm.

10. The apparatus of claim 1, wherein a pitch between adjacent optical device structures of the first plurality of optical device structures and the second plurality of optical device structures is arranged in a phase profile, and the phase profile varies from a center point of the phase profile to an exterior edge of the phase profile.

11. The apparatus of claim 10, wherein the pitch between adjacent optical device structures of the first plurality of optical device structures and the second plurality of optical device structures is between about 200 nm and about 1 μm.

12. An apparatus, comprising:
a light source operable to project one or more laser beams; and
an optical device, the optical device comprising:
a substrate, the substrate having a first surface and a second surface, the second surface opposite the first surface;
a field metasurface substrate coupled to the first surface, the field metasurface substrate having a third surface exposed to the light source;
a field metasurface disposed on the third surface, the field metasurface including a first plurality of optical device structures;
a collimation metasurface disposed on the first surface, the collimation metasurface including a second plurality of optical device structures operable to collimate the one or more laser beams through the substrate; and
a diffractive metasurface disposed on the second surface, the diffractive metasurface including a third plurality of optical device structures to diffract the one or more laser beams into diffraction beams.

13. The apparatus of claim 12, wherein the first plurality of optical device structures and the second plurality of optical device structures include an encapsulation material disposed around a sidewall of the first plurality of optical device structures and the second plurality of optical device structures.

14. The apparatus of claim 13, wherein the encapsulation material is disposed over a top surface of the first plurality of optical device structures and the second plurality of optical device structures.

15. The apparatus of claim 14, wherein the encapsulation material includes a polymer, a resin, or a silicon-containing material.

16. The apparatus of claim 12, wherein the substrate includes a substrate thickness of between about 50 μm and about 2 mm.

17. The apparatus of claim 12, wherein the field metasurface substrate includes a substrate thickness of between about 50 μm and about 2 mm.

18. The apparatus of claim 12, wherein the collimation metasurface, the diffractive metasurface, and the field metasurface have a structure thickness between about 100 nm and about 5 μm.

19. An apparatus, comprising:
a light source operable to project one or more laser beams; and
an optical device, the optical device comprising:
a substrate, the substrate having a first surface and a second surface, the second surface opposite the first surface, the first surface exposed to the light source;
a collimation metasurface disposed on the first surface, the collimation metasurface including a first plurality of optical device structures operable to collimate the one or more laser beams through the substrate, the first plurality of optical device structures arranged in a phase profile, wherein:
a structure width of the first plurality of optical device structures varies from a center point of the phase profile to an exterior edge of the phase profile; and
a diffractive metasurface disposed on the second surface, the diffractive metasurface including a second plurality of optical device structures to diffract the one or more laser beams into diffraction beams.

20. The apparatus of claim 19, wherein the structure width repeatedly decreases and increases in a plurality of cycles.
